(19) United States
(12) Patent Application Publication
(10) Pub. No.: US 2017/0353046 A1
(43) Pub. Date: Dec. 7, 2017

(54) MODULAR AND ASSEMBLABLE WIRELESS CHARGING SYSTEM AND DEVICE

(71) Applicant: QUALCOMM Incorporated, San Diego, CA (US)

(72) Inventors: Jen Chen, La Jolla, CA (US); William Henry Von Navak, San Diego, CA (US); Timothy Kerssen, San Diego, CA (US); Kelsey Burrell, Santee, CA (US); Charles Edward Wheatley, Del Mar, CA (US); Francesco Carobolante, San Diego, CA (US); Andrew Arnett, San Diego, CA (US); Yung-Ho Tsai, San Diego, CA (US); Xiaoyu Liu, San Diego, CA (US)

(21) Appl. No.: 15/171,759

(22) Filed: Jun. 2, 2016

(51) Int. Cl. H02J 7/02; H01F 38/14; H02J 50/12

(52) U.S. Cl. CPC H02J 7/025; H02J 50/12; H01F 38/14

(57) ABSTRACT

Devices and methods for distributing power are disclosed. For example, one device includes multiple assemblable elements, each assemblable element is configured to permit interlocking between one or more of the multiple assemblable elements. The multiple assemblable elements each include a portion of a coil. The portions of the coil are electrically interconnected and configured to provide wireless power to a receiving device.

### BACKGROUND

### Field

The present application relates generally to wireless power charging of chargeable devices, and more particularly, to modular and assemblable wireless charging systems, devices, and methods.

### Background

An increasing number and variety of electronic devices are powered via rechargeable batteries. Such devices include mobile phones, electric vehicles, portable music players, laptop computers, tablet computers, computer peripheral devices, communication devices (e.g., Bluetooth devices), digital cameras, hearing aids, and the like. While battery technology has improved, battery-powered electronic devices increasingly require and consume larger amounts of power, thereby often requiring recharging. Wireless charging systems permit recharging such devices through coupling a magnetic or electrical field generated by a transmit coil, included in a transmitter, to a receiver coil. Wireless charging systems using multiple transmit coils, each fed by a separate power amplifier, or single transmit coils having numerous turns may have advantages such as being able to provide wireless energy over a larger area, where that energy may be used for charging multiple devices. Additionally, the use of multiple transmit coils or numerous turns may provide a more uniform wireless field and may improve efficiency. However, the transmit coils are typically fixed in size covering a large area as required by the transmit coils. Further, being of a fixed size, the transmit coils are capable of charging receivers of predetermined sizes or a range of predetermined sizes. Thus, there is a need for systems and methods for providing a wireless charging systems capable of providing adaptable and modular transmit coils that can be dynamically modified so as to alter the size, area, and shape of the magnetic or electric filed generated by the transmit coil.

### SUMMARY

Various implementations of methods and apparatus within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims.

One aspect of the present disclosure provides a device for distributing power. The device includes multiple assemblable elements. Each assemblable element may be configured to permit interlocking between one or more of the multiple assemblable elements. The multiple assemblable elements include at least a first assemblable element including a first portion of a coil, and a second assemblable element including a second portion of the coil. The first and second portions of the coil are electrically interconnected and configured to provide wireless power. In some embodiments, the first assemblable element is configured to supply power from a power source to the other assemblable elements. In some embodiments, each assemblable element includes a portion of the coil, where the portions of the coil are electrically interconnected to form one or more coils. In some embodiments, the wireless power is provided based on the electrical interconnection of all portions of the coil. In some embodiments, the first and second portions of the coil are electrically interconnected through a coil in line and a coil out line. The assemblable elements may include an interlocking element, configured to permit the plurality of assemblable elements to be mechanically interconnected.

In some embodiments, the multiple assemblable elements are interconnected in an arrangement. In some embodiments, the multiple assemblable elements may include at least a third assemblable element. The third assemblable element may include a third portion of the coil, where the first, second and third portions of the coil are electrically interconnected and configured to provide wireless power. In one embodiment, the assemblable elements are arranged in a two-dimensional arrangement. In another embodiments, the assemblable elements are arranged in a three-dimensional arrangement. In some embodiments, the assemblable elements are tubular, where the assemblable elements are configured to interlock to form a tubular shaped coil.

In some embodiments, the coil includes multiple loops that may be based on the electrical interconnection of the plurality of assemblable elements. The multiple loops may include at least a first and second loop, where the first loop may be disposed on an outer most edge or periphery of the interlocking assemblable elements and the second loop may be disposed concentric to and nested within the first loop. In some embodiments, one of the assemblable elements may be a crossover assemblable element. The crossover assemblable element may include one or more switches configured to control the density of loops at the outer edge of the interlocked assemblable elements, and configured to periodically skip the second loop. In some embodiments, alternatively or in combination, the loops may include a passive loop.

Another aspect of the present disclosure provides a method for distributing power. The method includes providing multiple assemblable elements, where each assemblable element is configured to interlock between one or more of the assemblable elements and the each of the plurality of assemblable elements comprises a portion of a coil. The method also includes selectively interlocking the assemblable elements, where interlocking the assemblable elements electrically interconnects the portions of the coil. In some embodiments, selectively interlocking the assemblable elements further includes forming a coil comprising a plurality of loops based on electrically interconnecting the portions of the coil. In some embodiments, the loops may include a first loop and a second loop, the first loop disposed on the periphery of the interlocking assemblable elements and the second loop disposed concentric to and nested within the first loop. In one embodiment, the method also may include controlling the density of loops at the periphery based a crossover assemblable element comprising one or more switches. The method further includes providing wireless power by the coil.

In some embodiments, the method includes retrieving an arrangement for interlocking the assemblable elements stored in a database. The method may also include selectively interlock the assemblable elements is based on the arrangement of the plurality of assemblable elements. In some embodiments, the arrangement is two-dimensional. In other embodiments, the arrangement is three-dimensional.

In some implementations, the method may also include forming one or more coils by electrically interconnecting the portions of coil of the assemblable elements. In some embodiments, either in combination or alternatively, the method also includes supplying power from a power source to the assemblable elements via one of the assemblable elements.

Another aspect of the present disclosure provide another device for distributing power. The device includes a first means for creating a charging coil, the first means including a first portion of the charging coil. The device also includes a second means for creating a charging coil, the second means including a second portion of the charging coil. The first means for creating a charging coil is configured to interlock to the second means for creating a charging coil, and the first and second portions of the charging coil are electrically interconnected and configured to provide wireless power based on the interlocking of the first and second means for creating a charging coil.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Throughout the drawings, similar symbols typically identify similar components, unless context dictates otherwise. Note that the relative dimensions of the following figures may not be drawn to scale.

FIG. 1 is a functional block diagram of a wireless power transfer system, in accordance with an exemplary embodiment.

FIG. 2 is a functional block diagram of a wireless power transfer system, in accordance with an exemplary embodiment.

FIG. 3 is a schematic diagram of a portion of transmit circuitry or receive circuitry of FIG. 2 including a transmit or receive coil, in accordance with an exemplary embodiment.

FIG. 4 is a functional block diagram of a transmitter that can be used in the wireless power transfer system of FIG. 1, in accordance with an exemplary embodiment.

FIG. 5 is a functional block diagram of a receiver that can be used in the wireless power transfer system of FIG. 1, in accordance with an exemplary embodiment.

FIG. 6 is a schematic diagram of a portion of transmit circuitry that can be used in the transmitter of FIG. 4.

FIGS. 7A and 7B are perspective views of a modular transmit area, in accordance with an exemplary embodiment.

FIG. 8 is a perspective view of the modular transmit area of FIGS. 7A and 7B including an exemplary embodiment of a transmit coil, in accordance with an exemplary embodiment.

FIG. 9 is a perspective view of the modular transmit area of FIGS. 7A and 7B including another exemplary embodiment of a transmit coil, in accordance with an exemplary embodiment.

FIGS. 10A and 10B are perspective views of another modular transmit area, in accordance with an exemplary embodiment.

FIG. 11A is perspective views of a modular transmit area, in accordance with another exemplary embodiment.

FIGS. 11B-11E are perspective views of various assemblable elements, in accordance with an exemplary embodiment.

FIGS. 12A and 12B are perspective views of another modular transmit area and another embodiment of assemblable elements, in accordance with an exemplary embodiment.

FIGS. 13A through 13D are perspective views of a three-dimensional modular transmit area and three-dimensional assemblable elements, in accordance with an exemplary embodiment.

FIGS. 14A and 14B are perspective views of a tubular modular transmit area including tubular assemblable elements, in accordance with an exemplary embodiment.

FIGS. 15A and 15B are perspective views of another modular transmit area including hexagonal assemblable elements, in accordance with an exemplary embodiment.

FIG. 16 is perspective view of a three-dimensional modular transmit area including two-dimensional assemblable elements, in accordance with an exemplary embodiment.

FIG. 17 is perspective views of another modular transmit area having a dynamically modifiable transmit area, in accordance with an exemplary embodiment.

FIG. 18 is a flowchart of an exemplary method of wireless power transfer, in accordance with an exemplary embodiment.

### DETAILED DESCRIPTION

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “receive coil” to achieve power transfer. The term “coil” may also be referred to as an “antenna,” “loop antenna,” “resonator,” etc.

The terminology used herein is for the purpose of describing particular embodiments only and is not intended to be limiting of the disclosure. It will be understood by those within the art that if a specific number of a claim element is intended, such intent will be explicitly recited in the claim, and in the absence of such recitation, no such intent is present. For example, as used herein, the singular forms “a”, “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

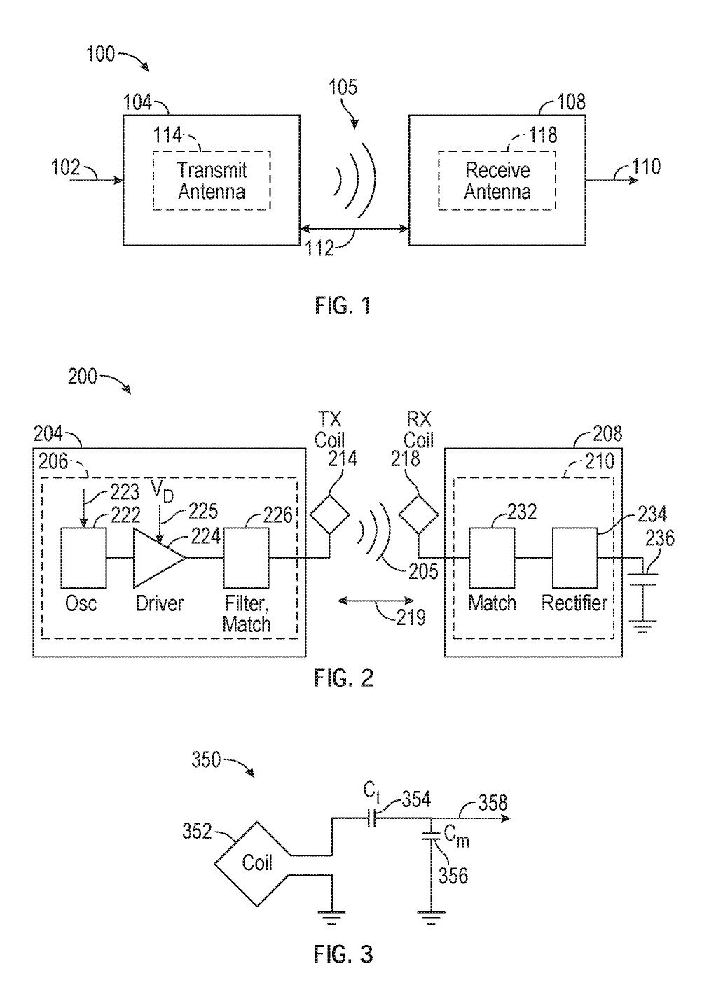

FIG. 1 is a functional block diagram of a wireless power transfer system 100, in accordance with one example implementation. An input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate an output power 110 for storing or consumption by a device (not shown in this figure) coupled to the output power 110. Both the transmitter 104 and the receiver 108 are separated by a distance 112.

In one example implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are minimal. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The transmitter 104 may include a transmit antenna or coil 114 for transmitting energy to the receiver 108. The receiver 108 may include a receive antenna or coil 118 for receiving or capturing energy transmitted from the transmitter 104. The near-field may correspond to a region in which there are strong reactive fields resulting from the currents and charges in the transmit coil 114 that minimally radiate power away from the transmit coil 114. The near-field may correspond to a region that is within about one wavelength (or a fraction thereof) of the transmit coil 114.

As described above, efficient energy transfer may occur by coupling a large portion of the energy in the wireless field 105 to the receive coil 118 rather than propagating most of the energy in an electromagnetic wave to the far field. When positioned within the wireless field 105, a “coupling mode” may be developed between the transmit coil 114 and the receive coil 118. The area around the transmit coil 114 and the receive coil 118 where this coupling may occur is referred to herein as a coupling-mode region.

FIG. 2 is a functional block diagram of a wireless power transfer system 200, in accordance with another example implementation. The system 200 may be a wireless power transfer system of similar operation and functionality as the system 100 of FIG. 1. However, the system 200 provides additional details regarding the components of the wireless power transfer system 200 than FIG. 1. The system 200 includes a transmitter 204 and a receiver 208. The transmitter 204 may include a transmit circuitry 206 that may include an oscillator 222, a driver circuit 224, and a filter and matching circuit 226. The oscillator 222 may be configured to generate a signal at a desired frequency (e.g., a resonant frequency) that may be adjusted in response to a frequency control signal 223. The oscillator 222 may provide the oscillator signal to the driver circuit 224. The driver circuit 224 may be configured to drive the transmit coil 214 at, for example, a resonant frequency of the transmit coil 214 based on an input voltage signal (VD) 225. The transmitter 204 can receive input voltage signal 225 through a number of power sources, such as, for example, an AC-DC converter (not shown) to convert conventional AC power present in a building, a DC-DC converter (not shown) to convert a conventional DC power source to a voltage suitable for the transmitter 204, or directly from a conventional DC power source (not shown). In some embodiments, the driver circuit 224 may be a switching amplifier configured to receive a square wave from the oscillator 222 and output a sine wave. For example, the driver circuit 224 may be a class E amplifier.

The filter and matching circuit 226 may filter out harmonics or other unwanted frequencies and match the impedance of the transmitter 204 to the transmit coil 214. As a result of driving the transmit coil 214, the transmit coil 214 may generate a wireless field 205 to wirelessly output power at a level sufficient for charging a battery 236, for example.

The receiver 208 may include a receive circuitry 210 that may include a matching circuit 232 and a rectifier circuit 234. The matching circuit 232 may match the impedance of the receive circuitry 210 to a receive coil 218. The rectifier circuit 234 may generate a direct current (DC) power output from an alternate current (AC) power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. Transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

As discussed above, both transmitter 204 and receiver 208 are separated by a distance and may be configured according to a mutual resonant relationship to minimize transmission losses between the transmitter 204 and the receiver 208. When the transmit coil 214 and the receive coil 218 are mutually resonant and in close proximity, the wireless power transfer system 200 may be described as a strongly coupled regime where the coupling coefficient (coupling coefficient k) is typically above 0.3. In some embodiments, the coupling coefficient k between the transmitter 204 and receiver 208 may vary based on at least one of the distance between the two corresponding coils or the size of the corresponding coils, etc.

FIG. 3 is a schematic diagram of a portion of the transmit circuitry 206 or the receive circuitry 210 of FIG. 2, in accordance with some example implementations. As illustrated in FIG. 3, a transmit or receive circuitry 350 may include an coil 352. The antenna 352 may also be referred to or be configured as a “loop” antenna 352 or a resonator. The coil 352 may also be referred to herein or be configured as a “magnetic” coil or an induction coil. The term “coil” generally refers to a component that may wirelessly output or receive energy for coupling to another “coil.” The coil may also be referred to as an antenna of a type that is configured to wirelessly output or receive power. As used herein, the coil 352 is an example of a “power transfer component” of a type that is configured to wirelessly output and/or receive power.

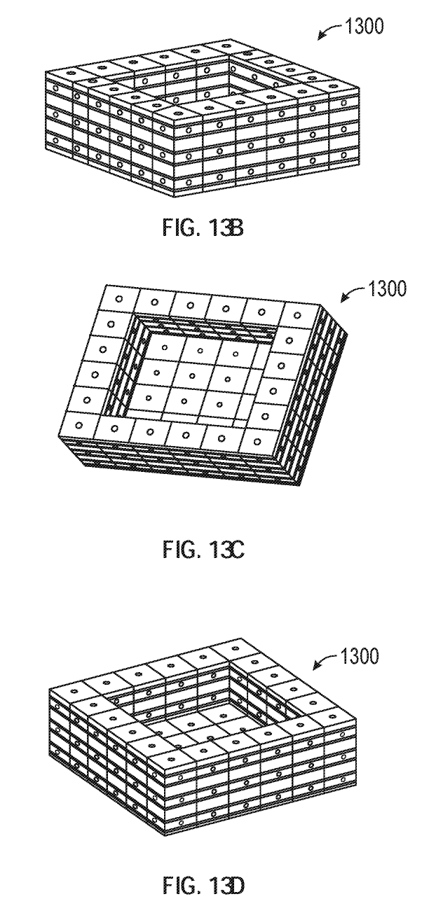

The coil 352 may include an air core or a physical core such as a ferrite core (not shown in this figure). Air core loop antennas may be more tolerable to extraneous physical devices placed in the vicinity of the core. Furthermore, an air core loop antenna 352 allows the placement of other components within the core area. In addition, an air core loop may more readily enable placement of the receive coil 218 (FIG. 2) within a plane of the transmit coil 214 (FIG. 2) where the coupled-mode region of the transmit coil 214 may be more powerful. For example, such that the receiver coil is partially or fully encompassed or surrounded by the transmit coil within the plane of the transmit coil, as will be described below in connection with FIGS. 13A-16.

As stated, efficient transfer of energy between the transmitter 104 (transmitter 204 as referenced in FIG. 2) and the receiver 108 (receiver 208 as referenced in FIG. 2) may occur during matched or nearly matched resonance between the transmitter 104 and the receiver 108. However, even when resonance between the transmitter 104 and receiver 108 are not matched, energy may be transferred, although the efficiency may be affected. For example, the efficiency may be less when resonance is not matched. Transfer of energy occurs by coupling energy from the wireless field 105 (wireless field 205 as referenced in FIG. 2) of the transmit coil 114 (transmit coil 214 as referenced in FIG. 2) to the receive coil 118 (receive coil 218 as referenced in FIG. 2), residing in the vicinity of the wireless field 105, rather than propagating the energy from the transmit coil 114 into free space.

The resonant frequency of the loop or magnetic coils is based on the inductance and capacitance. Inductance may be simply the inductance created by the coil 352, whereas, capacitance may be added to the coil's inductance to create a resonant structure at a desired resonant frequency. As a non-limiting example, a capacitor 354 and a capacitor 356 may be added to the transmit or a receive circuitry 350 to create a resonant circuit that selects a signal 358 at a resonant frequency. Accordingly, for larger diameter coils, the size of capacitance needed to sustain resonance may decrease as the diameter or inductance of the loop increases.

Furthermore, as the diameter of the coil increases, the efficient energy transfer area of the near-field may increase. Other resonant circuits formed using other components are also possible. As another non-limiting example, a capacitor may be placed in parallel between the two terminals of the circuitry 350. For transmit coils, the signal 358, with a frequency that substantially corresponds to the resonant frequency of the coil 352, may be an input to the coil 352.

In FIG. 1, the transmitter 104 may output a time varying magnetic (or electromagnetic) field with a frequency corresponding to the resonant frequency of the transmit coil 114. When the receiver 108 is within the wireless field 105, the time varying magnetic (or electromagnetic) field may induce a current in the receive coil 118. As described above, if the receive coil 118 is configured to resonate at the frequency of the transmit coil 114, energy may be efficiently transferred. The AC signal induced in the receive coil 118 may be rectified as described above to produce a DC signal that may be provided to charge or to power a load.

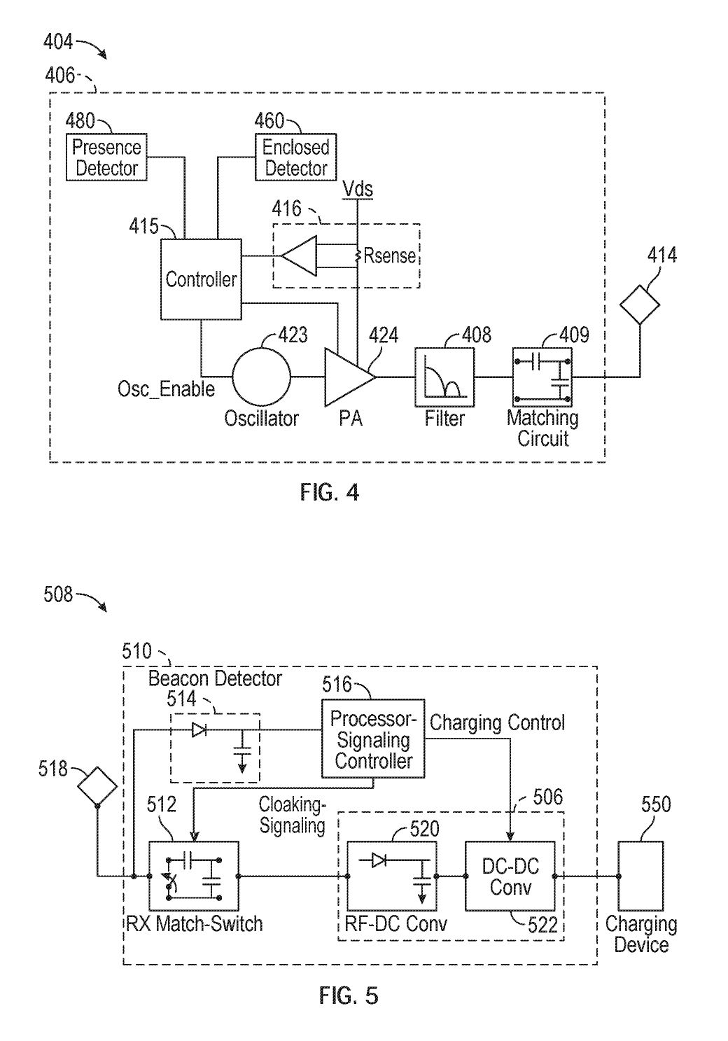

FIG. 4 is a functional block diagram of a transmitter 404 that can be used in the wireless power transfer system of FIG. 1, in accordance with exemplary embodiments of the present disclosure. The transmitter 404 can include transmit circuitry 406 and a transmit coil 414. The transmit coil 414 can be the coil 352 as shown in FIG. 3. Transmit circuitry 406 can provide RF power to the transmit coil 414 by providing an oscillating signal resulting in generation of energy (e.g., magnetic flux) about the transmit coil 414. Transmitter 404 can operate at any suitable frequency. By way of example, transmitter 404 can operate at the 13.56 MHz ISM band.

The transmit circuitry 406 can include a fixed impedance matching circuit 409 for presenting a load to the driver circuit 424 such that the efficiency of power transfer from DC to AC is increased or maximized. The transmit circuitry 406 can further include a low pass filter (LPF) 408 configured to reduce harmonic emissions to levels to prevent self-jamming of devices coupled to receivers 108 (FIG. 1). Other exemplary embodiments can include different filter topologies, including but not limited to, notch filters that attenuate specific frequencies while passing others and can include an adaptive impedance match, that can be varied based on measurable transmit metrics, such as output power to the transmit coil 414 or DC current drawn by the driver circuit 424. Transmit circuitry 406 further includes a driver circuit 424 configured to drive an RF signal as determined by an oscillator 423. The transmit circuitry 406 can be comprised of discrete devices or circuits, or alternately, can be comprised of an integrated assembly. An exemplary RF power output from transmit coil 414 can be around 1 Watt-10 Watts, such as around 2.5 Watts.

Transmit circuitry 406 can further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 can also be referred to herein as a processor 415. Adjustment of oscillator phase and related circuitry in the transmission path can allow for reduction of out of band emissions, especially when transitioning from one frequency to another.

The transmit circuitry 406 can further include a load sensing circuit 416 for detecting the presence or absence of active receivers in the vicinity of the near-field generated by transmit coil 414. By way of example, the load sensing circuit 416 monitors the current flowing to the driver circuit 424, that can be affected by the presence or absence of active receivers in the vicinity of the field generated by transmit coil 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 can be used to determine whether a receiving device is positioned within a wireless power transfer region of the transmitter 404.

The transmit coil 414 can be implemented with a Litz wire or as an antenna strip with the thickness, width and metal type selected to keep resistive losses low. In one embodiment, the transmit coil 414 can generally be configured for association with a larger structure such as a table, mat, lamp or other less portable configuration. Accordingly, the transmit coil 414 generally may not need “turns” in order to be of a practical dimension. An exemplary embodiment of a transmit coil 414 can be “electrically small” (i.e., fraction of the wavelength) and tuned to resonate at lower usable frequencies by using capacitors to define the resonant frequency.

The transmitter 404 can gather and track information about the whereabouts and status of receiver devices that can be associated with the transmitter 404. Thus, the transmit circuitry 406 can include a presence detector 480, an enclosed detector 460, or a combination thereof, connected to the controller 415 (also referred to as a processor herein). The controller 415 can adjust an amount of power delivered by the driver circuit 424 in response to presence signals from the presence detector 480 and the enclosed detector 460. The transmitter 404 can receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 can be a motion detector utilized to sense the initial presence of a device to be charged that is inserted into the coverage area of the transmitter 404. After detection, the transmitter 404 can be turned on and the RF power received by the device can be used to toggle a switch on the receive device in a pre-determined manner, which in turn results in changes to the driving point impedance of the transmitter 404.

As a non-limiting example, the enclosed detector 460 (can also be referred to herein as an enclosed compartment detector or an enclosed space detector) can be a device such as a sense switch for determining when an enclosure is in a closed or open state. When a transmitter is in an enclosure that is in an enclosed state, a power level of the transmitter can be increased.

In exemplary embodiments, a method by which the transmitter 404 does not remain on indefinitely can be used. In this case, the transmitter 404 can be programmed to shut off after a user-determined amount of time. This feature prevents the transmitter 404, notably the driver circuit 424, from running long after the wireless devices in its perimeter area fully charged and/or no longer present in the wireless field. This event can be due to the failure of the circuit to detect the signal sent from either the repeater or the receive coil that a device is fully charged. To prevent the transmitter 404 from automatically shutting down if another device is placed in its perimeter, the transmitter 404 automatic shut off feature can be activated only after a set period of lack of motion detected in its perimeter. The user can be able to determine the inactivity time interval and change it as desired. As a non-limiting example, the time interval can be longer than that needed to fully charge a specific type of wireless device under the assumption of the device being initially fully discharged.

FIG. 5 is a functional block diagram of a receiver 508 that can be used in the wireless power transfer system of FIG. 1, in accordance with exemplary embodiments of the present disclosure. The receiver 508 includes receive circuitry 510 that can include a receive coil 518. Receiver 508 further couples to device 550 for providing received power thereto. It should be noted that receiver 508 is illustrated as being external to device 550 but can be integrated into device 550. Energy can be propagated wirelessly to receive coil 518 and then coupled through the rest of the receive circuitry 510 to device 550. By way of example, the charging device can include devices such as mobile phones, portable music players, laptop computers, tablet computers, computer peripheral devices, communication devices (e.g., Bluetooth devices), digital cameras, hearing aids (and other medical devices), and the like.

Receive coil 518 can be tuned to resonate at the same frequency, or within a specified range of frequencies, as transmit coil 414 (FIG. 4). Receive coil 518 can be similarly dimensioned with transmit coil 414 or can be differently sized based upon the dimensions of the associated device 550. By way of example, device 550 can be a portable electronic device having diametric or length dimension smaller than the diameter or length of transmit coil 414. In such an example, receive coil 518 can be implemented as a multi-turn coil in order to reduce the capacitance value of a tuning capacitor (not shown) and increase the receive coil's impedance. By way of example, receive coil 518 can be placed around the substantial circumference of device 550 in order to maximize the coil diameter and reduce the number of loop turns (e.g., windings) of the receive coil 518 and the inter-winding capacitance.

Receive circuitry 510 can provide an impedance match to the receive coil 518. Receive circuitry 510 includes power conversion circuitry 506 for converting a received RF energy source into charging power for use by the device 550. Power conversion circuitry 506 includes an RF-to-DC converter 520 and can also in include a DC-to-DC converter 522. RF-to-DC converter 520 rectifies the RF energy signal received at receive coil 518 into a non-alternating power with an output voltage represented by Vrect. The DC-to-DC converter 522 (or other power regulator) converts the rectified RF energy signal into an energy potential (e.g., voltage) that is compatible with device 550 with an output voltage and output current represented by Vout and Iout. Various RF-to-DC converters are contemplated, including partial and full rectifiers, regulators, bridges, doublers, as well as linear and switching converters.

Receive circuitry 510 can further include switching circuitry 512 for connecting receive coil 518 to the power conversion circuitry 506 or alternatively for disconnecting the power conversion circuitry 506. Disconnecting receive coil 518 from power conversion circuitry 506 not only suspends charging of device 550, but also changes the “load” as “seen” by the transmitter 404 (FIG. 2).

As disclosed above, transmitter 404 includes load sensing circuit 416 that can detect fluctuations in the bias current provided to transmitter driver circuit 424. Accordingly, transmitter 404 has a mechanism for determining when receivers are present in the transmitter's near-field.

In some embodiments, a receiver 508 can be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 can provide a communication mechanism from receiver 508 to transmitter 404 as is explained more fully below. Additionally, a protocol can be associated with the switching that enables the sending of a message from receiver 508 to transmitter 404. By way of example, a switching speed can be on the order of 100 μsec.

In an exemplary embodiment, communication between the transmitter 404 and the receiver 508 refers to a device sensing and charging control mechanism, rather than conventional two-way communication (i.e., in band signaling using the coupling field). In other words, the transmitter 404 can use on/off keying of the transmitted signal to adjust whether energy is available in the near-field. The receiver can interpret these changes in energy as a message from the transmitter 404. From the receiver side, the receiver 508 can use tuning and de-tuning of the receive coil 518 to adjust how much power is being accepted from the field. In some cases, the tuning and de-tuning can be accomplished via the switching circuitry 512. The transmitter 404 can detect this difference in power used from the field and interpret these changes as a message from the receiver 508. It is noted that other forms of modulation of the transmit power and the load behavior can be utilized.

Receive circuitry 510 can further include signaling detector and beacon circuitry 514 used to identify received energy fluctuations, that can correspond to informational signaling from the transmitter to the receiver. Furthermore, signaling and beacon circuitry 514 can also be used to detect the transmission of a reduced RF signal energy (e.g., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Cloaking of receiver 508 can also occur upon the occurrence of other events including detection of an external wired charging source (e.g., wall/USB power) providing charging power to device 550. Processor 516, in addition to controlling the cloaking of the receiver, can also monitor signaling detector and beacon circuitry 514 to determine a beacon state and extract messages sent from the transmitter 404. Processor 516 can also adjust the DC-to-DC converter 522 for improved performance.

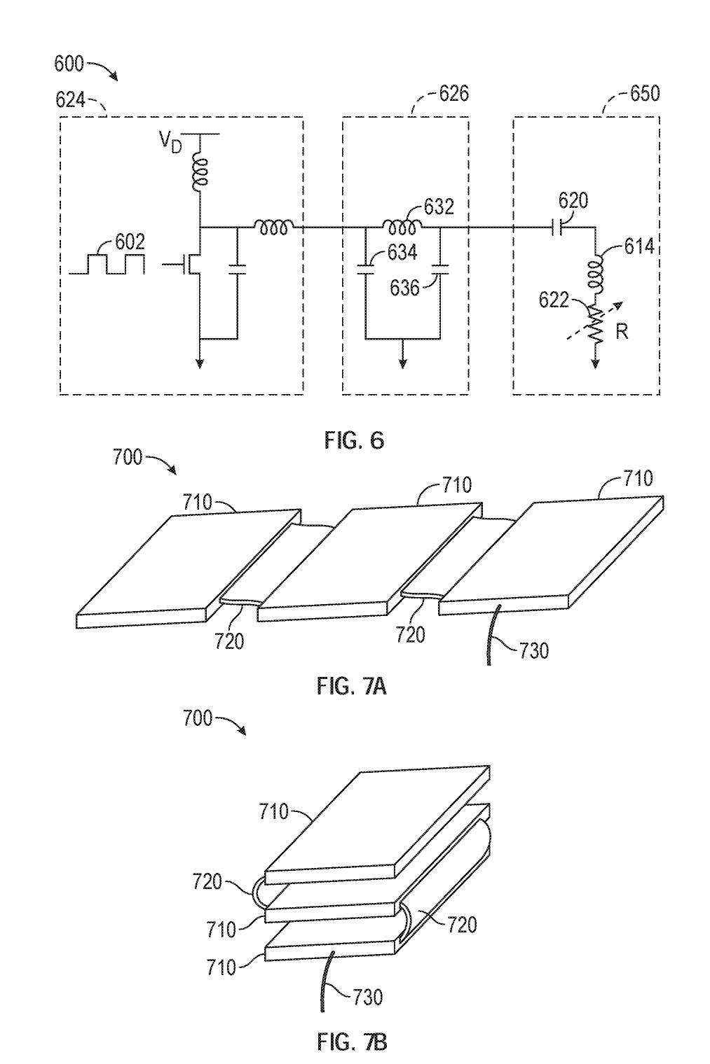

FIG. 6 is a schematic diagram of a portion of transmit circuitry 600 that can be used in the transmit circuitry 406 of FIG. 4. The transmit circuitry 600 can include a driver circuit 624 as described above in FIG. 4. As described above, the driver circuit 624 can be a switching amplifier that can be configured to receive a square wave and output a sine wave to be provided to the transmit circuit 650. In some cases, the driver circuit 624 can be referred to as an amplifier circuit. The driver circuit 624 is shown as a class E amplifier; however, any suitable driver circuit 624 can be used in accordance with embodiments of the present disclosure. The driver circuit 624 can be driven by an input signal 602 from an oscillator 423 as shown in FIG. 4. The driver circuit 624 can also be provided with a drive voltage VD that is configured to control the maximum power that can be delivered through a transmit circuit 650. To eliminate or reduce harmonics, the transmit circuitry 600 can include a filter circuit 626. In some embodiments, the filter circuit 626 can be a three pole (capacitor 634, inductor 632, and capacitor 636) low pass filter circuit 626.

The signal output by the filter circuit 626 can be provided to a transmit circuit 650 comprising a coil 614. The transmit circuit 650 can include a series resonant circuit having a capacitance 620 and inductance that can resonate at a frequency of the filtered signal provided by the driver circuit 624. In various embodiments, the coil or an additional capacitor component can create the inductance or capacitance. The load of the transmit circuit 650 can be represented by the variable resistor 622. The load can be a function of a wireless power receiver 508 that is positioned to receive power from the transmit circuit 650.

In various embodiments, the efficiency of power transfer of a wireless power transfer system is proportional to how closely the transmit coil and receive coil can be aligned with one another. For example, how closely the wireless field radiating from the transmitter can be aligned with the receive coil of a receiver. Typically, a transmitter, including a transmit coil, and a receiver, including a receiver coil, are aligned by a user of the wireless power transfer system such that the receive coil is positioned within the wireless field produced by the transmit coil (e.g., the coupling mode). Conventionally, transmitters are fixed in size, and as such the transmit coils are capable of charging only one predetermined receiver size or a single range of receiver sizes.

Various embodiments disclosed herein relate to dynamic or modular transmit areas comprising one or more coils for use with wireless power transfer systems. Some embodiments disclosed herein relate to foldable transmit areas. Other embodiments, disclosed herein relate to assemblable transmit areas for use with wireless power transfer systems. For example, a plurality of assemblable transmit areas or elements, containing at least a portion of a coil therein, may be configured to interlock into various shapes and sizes. In various embodiments, the interlocking of the plurality of assemblable elements electrically interconnects the portions of the coil to provide wireless power transfer. In some embodiments, the assemblable elements may be interconnected or assembled into a two-dimensional shape, while in other embodiments, the shape may be three-dimensional. Other embodiments disclosed herein relate to methods for configuring transmit coils within and among the modular or assemblable elements, either in a specific or a random arrangement. For, example a transmit area may comprise multiple portions of a coil that may be configured into a plurality of coils for generating a wireless field, each coil may be dynamically reconfigurable (e.g., switched and reshaped) due to the multiple portions and based on the power receiving requirements of the receiver. As such, embodiments disclosed herein describe wireless power transfer systems that are modular and assemblable, for example, to provide flexibility in charging various sizes or shapes of receivers or to assist with storage. Such embodiments may be expanded or assembled to provide a variety of transmit areas that are capable of providing efficient wireless power transfer.

As used herein and throughout this disclosure, the term “assemblable elements” may refer to one or more transmitters, for example, such as transmitters 204 and/or 404 of FIGS. 2 and 4, respectively. In some embodiments, the assemblable elements may be a circuit board comprising a printed circuit board (PCB) containing the coil and other transmit circuitry of each assemblable elements. In some embodiments, an assemblable element may be a transmitter 204 or 404 comprising all the transmit circuitry described in connection with FIGS. 1-6. In other embodiments, the assemblable element may comprise some or none of the transmit circuitry described in connection with FIGS. 1-6. For example, an assemblable element may comprise a transmit coil 214 and a power amplifier such as drive circuit 224 or 424. Accordingly, the assemblable element may include various communication or synchronization lines, configured to exchange control signal from one or more controllers (e.g., controller 415 of FIG. 4). For example, a transmit area may comprise multiple assemblable elements where one assemblable element includes a controller. The controller may be configured to send control signals over a synchronization line to adjust frequency and phase of oscillators (e.g., oscillator 423 of FIG. 4) included in the other assemblable elements. Other configurations are possible, as described herein.

In some implementations, a wireless power transfer system is provided for distributing power that may be foldable or modular. For example, the wireless power transfer system may include a transmit area comprising a plurality of rigid segments arranged in a first arrangement. The plurality of rigid segments may be connected by a plurality of hinges disposed between the plurality of rigid segments. The plurality of hinges may be configured to permit the rigid segments be arranged into a second arrangement (e.g., folded into various configurations, assembled or dissembled, etc.). In some embodiments, at least one coil configured to provide wireless power is disposed in at least one of the plurality of rigid segments. In some embodiments, the coil is a single coil having multiple turns that is disposed amongst the plurality of rigid segments and the plurality of hinges. In another embodiment, the coil comprises a plurality of individual coils or portions of a coil, where each of the plurality of coils is disposed in one of the rigid segments.

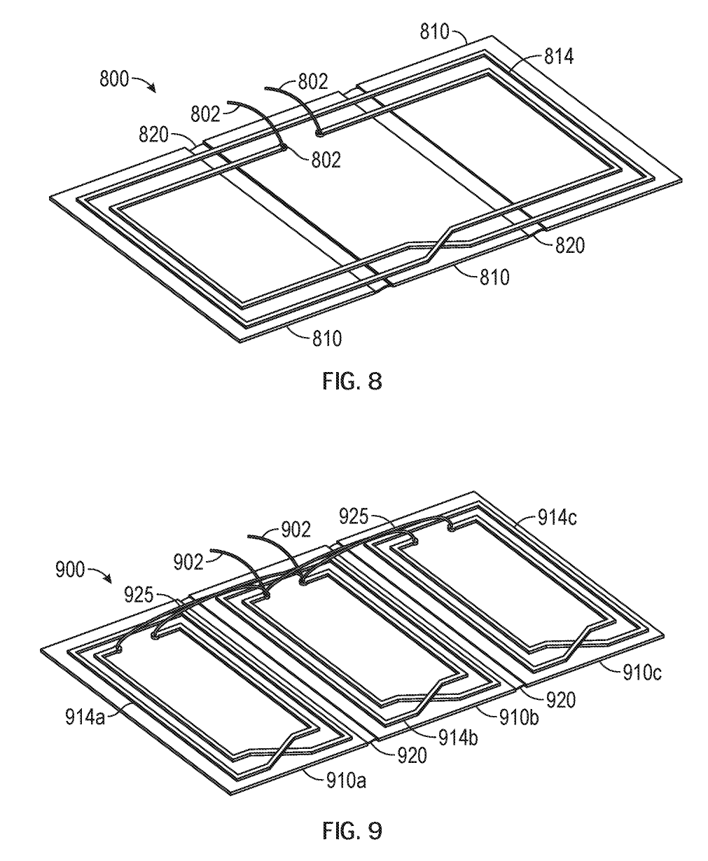

FIGS. 7A and 7B are perspective views of an exemplary transmit area 700 in accordance with an exemplary embodiment. FIG. 7A illustrates transmit area 700, including multiple rigid segments 710 configured in an expanded arrangement. FIG. 7A also illustrates multiple connection segments 720 disposed between the multiple rigid segments 710. FIG. 7B illustrates a second arrangement of the multiple rigid segments 710 facilitated by use of the connection segments 720. For example, as illustrated in FIG. 7B, the second arrangement is a compact folded or stacked arrangement, where the expanded arrangement of FIG. 7A may be unfolded into a larger area suitable for charging several devices.

In some embodiments, the rigid segments 710 may be similar to assemblable elements of the transmit area, as described above and throughout this disclosure. For example, rigid segments 710 may be constructed a circuit board comprising a printed circuit board (PCB) containing the coil and other transmit for generating a wireless field for wireless power transfer. In some embodiments, rigid segments may collectively comprise a transmitter 204 or 404 including all the transmit circuitry described in connection with FIGS. 1-6. In other embodiments, rigid segments 710 may individually comprise a transmitter 204 and/or 404. In other embodiments, the assemblable element may comprise some or none of the transmit circuitry described in connection with FIGS. 1-6.

In some embodiments, the transmit area 700 may be configured as a wireless power transfer system, as described above with respect to FIGS. 1-6, that may have multiple arrangements for wirelessly transferring power, storage, and/or compact mobility. The transmit area 700 may include a power input line 730 configured to provide input power to transmit area 700 from a power source (not shown) to generate a wireless field for performing energy transfer.

In some embodiments, switching between a first and second arrangement may be facilitated by the connection segments 720. In some embodiments, the connection segments facilitate switching between the first and second arrangements illustrated in FIGS. 7A and 7B. For example, connection segments 720 may be flexible material configured to bend or fold, such that transmit area 700 may be switched between a stacked or folded arrangement (as shown in FIG. 7B) and an expanded or planar arrangement (as shown in FIG. 7A). For example, connection segments 720 may be a thin flexible PCB that may be bent or rolled up. Portions of the transmit coil, included in the transmit area 700, may be made of wires capable of bending without breaking the electrical connection. In other embodiments, connection segments 720 may be rigid hinges similar to a hinge of a doorway, which facilitates the switching between the first and second arrangements. In the above embodiments, the wireless power transfer system may be configured to operate in either the first or second arrangement. For example, the transmit area 700 may be configured to generate a wireless field for performing energy transfer in the folded state of FIG. 7B or unfolded state of FIG. 7A based on the wireless power transfer requirements of the receiver.

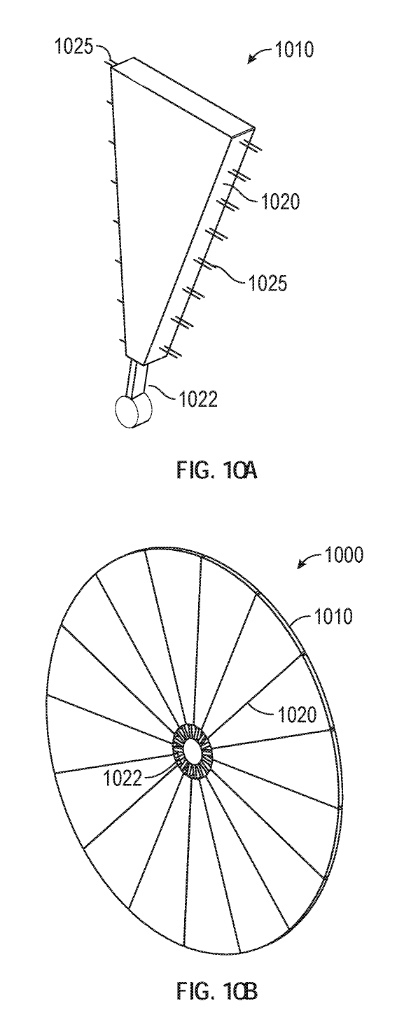

FIGS. 8 and 9 are perspective views of exemplary embodiment transmit coils included in transmit areas 800 and 900, respectively. The transmit areas 800 and 900 may be substantially similar to transmit area 700 of FIGS. 7A and 7B, however, the configuration of the rigid segments and transmit coils therein are different.

For example, FIG. 8 illustrates an embodiment of transmit area 800 including one or more transmit coils 814 constructed between and throughout the multiple rigid segments 810 and connection segments 820. The various components, aside from coil 814, of a wireless power transfer system described above in FIGS. 1-6 may be included in one or more rigid segments 810. For example, while transmit coil 814 is dispersed among the various rigid segments 810 and connection segments 820, the transmit circuitry (e.g., oscillator 222, a driver circuit 224, and a filter and matching circuit 226 of FIG. 2) may be included in a single rigid segment 810 or dispersed among the rigid segments 810. The transmit area 800 may also include electrical connections 802 connected to the positive and negative terminals of a power source (not shown) configured to provide input power to transmit area 800 to generate a wireless field for performing energy transfer.

In another embodiment depicted in FIG. 9, each rigid segment 910a-c may include a separate transmit coil 914a-c. In some variations, each transmit coil 914a-c may be connected in parallel through connection lines 925, as described below in FIG. 9. In some embodiments, connection lines 925 may be embedded in connection segment 920. In other variations, each transmit coil 914a-c may be connected in series with each other (not shown). In some embodiments, each rigid segment 910a-c may be a single wireless power transfer system including the various components described above with reference to FIGS. 1-6. In other embodiments, one or more rigid segments 910a-c may include one or more of the various comments described above with reference to FIGS. 1-6. For example, rigid segment 910b may be a master rigid segment that is similar to the transmitters 204 or 404 of FIGS. 2 and 4, respectively. The transmit area 900 may also include electrical connections 902 connected to the positive and negative terminals of a power source (not shown) configured to provide input power to transmit area 900 to generate a wireless field for performing energy transfer.

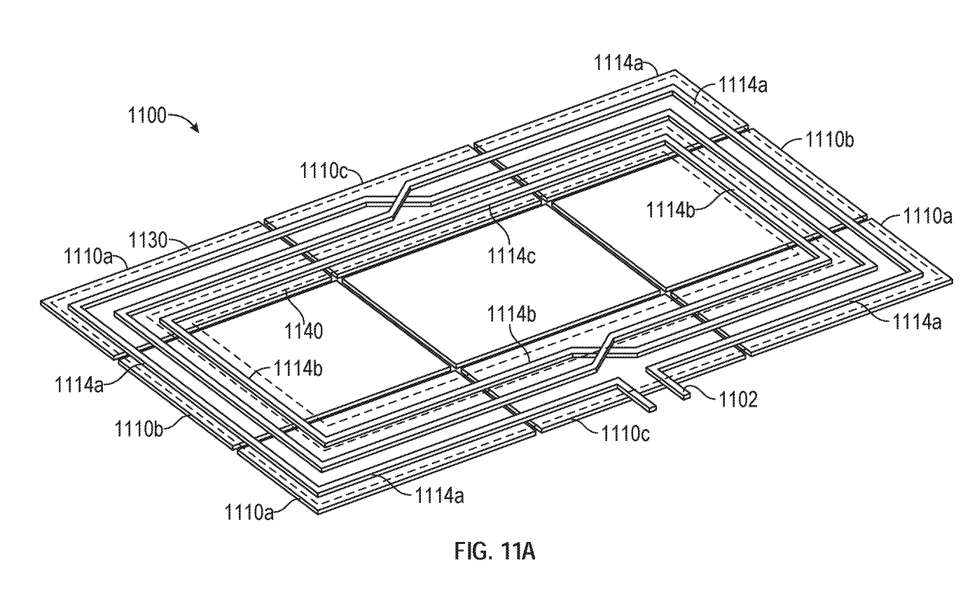

While the embodiments described illustrate transmit areas having a rectangular shape that may be stacked or folded as described above, it will be understood that any arrangement is possible based on the wireless power transfer requirements, as described above, of the receiver. For example, FIGS. 10A and 10B depict a perspective view of another embodiment of a wireless power transfer system having a first and second arrangement. In this embodiment, transmit area 1000 may comprise a coil compacted about pivot point 1022. FIG. 10A illustrates the embodiment in a first arrangement, for example, a folded or compacted state. FIG. 10B illustrates the embodiment in a second arrangement, for example, an unfolded or expanded state. As described above, transmit area 1000 may include a single coil throughout and among the rigid segments 1010 or comprise multiple coils contained within each rigid segment 1010. In some embodiments, the rigid segments 1010 may have connection segments or edges 1020 comprising interlocking elements 1025. Interlocking elements 1025 may be any means of mechanically connecting two adjacent rigid segments 1010, such that the adjacent rigid segments do not move relative to each other. Some example interlocking elements may include magnets, latches, snaps, zippers. Velcro®, male/female connection section (e.g., similar to a puzzle piece), etc. Other interlocking elements are possible.

In some embodiments, a modular wireless power transfer system may comprise a plurality of assemblable elements configured to be interlocked to form wireless power transfer system. In some embodiments, assemblable elements can be re-used and re-assembled into various shapes and sizes, thereby permitting differently shaped wireless power systems from a collection of assemblable elements. In some embodiments, the modular wireless power transfer system may include a dynamically reconfigurable transmit coil made of the assemblable elements.

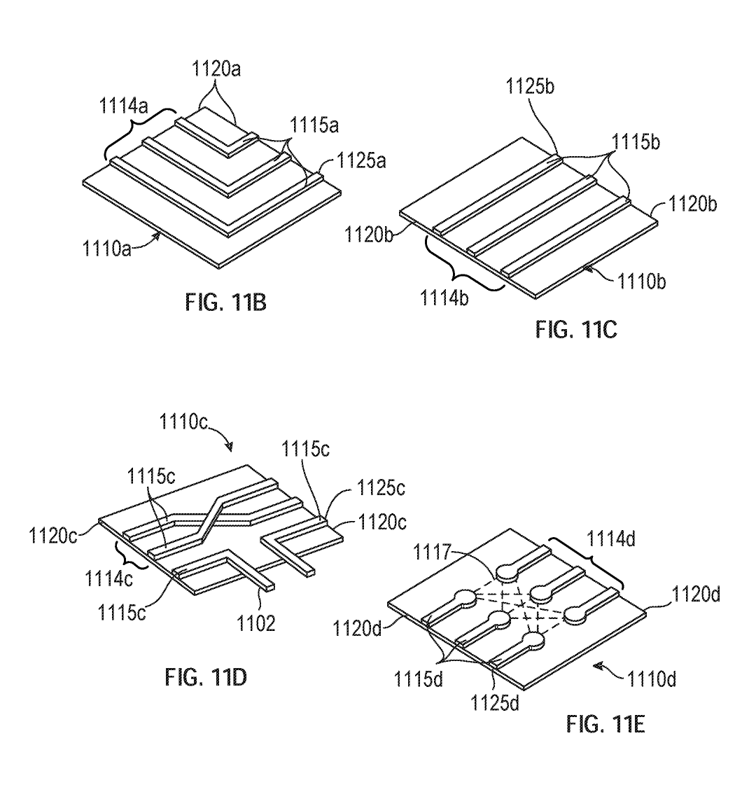

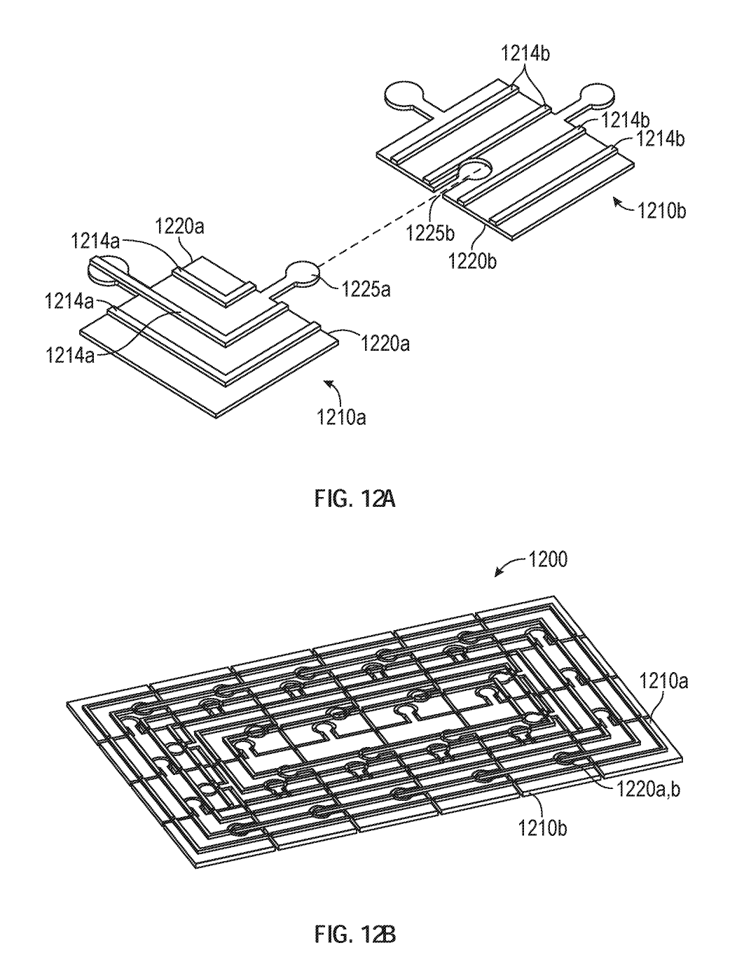

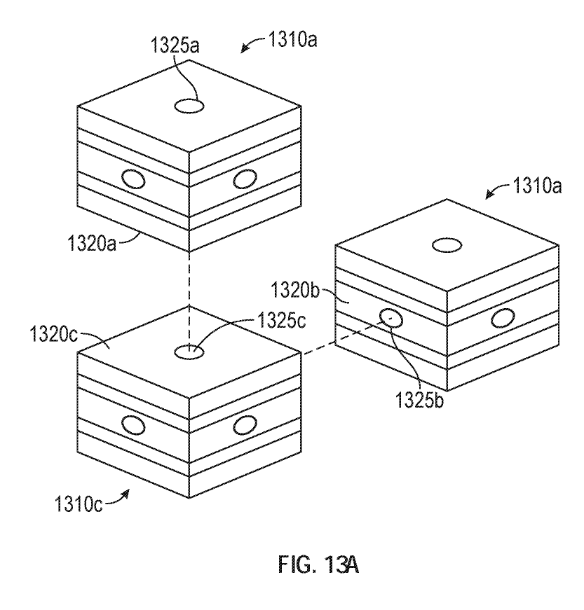

FIG. 11A is a schematic perspective view of an exemplary transmit area 1100 in accordance with an exemplary embodiment. Transmit area 1100 may be a transmitter or may be part of a transmitter of wireless power transfer system 100 of FIG. 1, the transmit area 1100 being configured to generate a wireless field for providing energy transfer to a receiver. The transmit area 700 may comprise a plurality of assemblable elements 1110a-e. Each assemblable element 1110a-e can be configured to interlock to one or more neighboring assemblable elements 1110a-e via an interlocking element (not shown). For example, the assemblable elements 1110 may be interconnected in a manner similar to Legos®, puzzle pieces (e.g., as shown in FIGS. 12A and 12B), or any interlocking device as described above, such that the plurality of assemblable elements 1110 connected to create a single transmit area 1100. In other embodiments, the assemblable elements may include male and female connection portions that mate to connect the assemblable elements 1110. In some embodiments, the edges 1120 of the assemblable elements 1110 may be constructed so that each piece may be fit together or interconnect with neighboring assemblable elements through compatible connections, both mechanical and electrical, such that power and electrical signals may be passed between each tile.

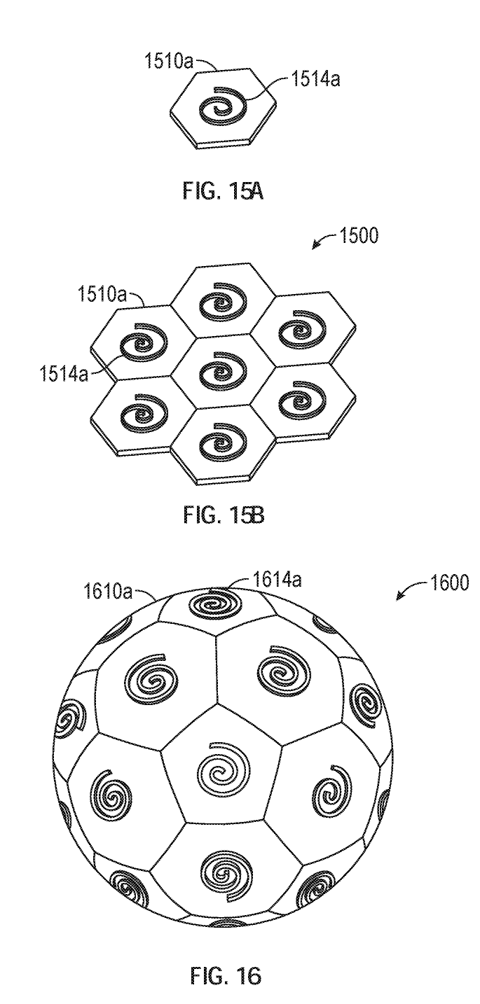

In some embodiments, the assemblable elements 1110 may be tiles (as illustrated in FIG. 11A-11E), however it will be understood that the concepts and embodiments disclosed herein are not to be limited as such. For example, the assemblable elements 1110 may be blocks (as illustrated in FIG. 13A-13D). Assemblable elements 1110 can be of various geometries (e.g., square, hexagonal, pentagonal, circular, etc.), allowing a wide variety of configurations. Furthermore, the assemblable elements 1110 may be two-dimensional with minimal thickness or three-dimensional (e.g., a block or cube, pyramid, tetrahedron, dodecahedron, etc.) such that the assemblable elements may be assembled into various shapes (e.g., 2D or 3D), sizes, and arrangements. For example, charging elements may be interconnected to form a flat continuous surface using square or hexagonal blocks, a bowl shape using hexagonal and pentagonal blocks together as illustrated in FIGS. 15A-16, etc. One non-limiting advantage of the different shapes or arrangements of assemblable elements allows for a plurality of arrangements of transmit area 1100 to optimally and efficiently charge differently shaped devices, space constraints with the location of the transmit area within a user's personal space, and personal aesthetics of a user. For example, a desk or table may be constructed out of assemblable elements to allow such a structure to support wireless charging. Other configurations are possible, such that the assemblable elements 1110 may be interlocked with one or more neighboring assemblable elements 1110 to form single transmit area 1100 from the plurality of assemblable elements 1110.

Each assemblable element 1110 includes at least a portion of the coil 1114. Each assemblable element 1110 may include a portion of a coil or transmit coil 1114a-d. In various embodiments, when the assemblable elements 1110 are interlocked, the plurality of portions of the coil 1114 may be electrically interconnected. For example, the coil may comprise wires or conductors and the transmit circuitry as described above in FIGS. 1-6 can be brought into contact to facilitate the exchange of electrical signals amongst the portions of the coil 1114. By applying input power via power input 1102 connected to a power source, and in accordance with the description above in connection with FIGS. 1-6, the plurality of portions form one or more transmit coils configured to generate a wireless field to provide energy transfer. In some embodiments, a single assemblable element 1110 may comprise a transmit coil capable of generating a wireless field on its own.

FIGS. 11B-11E illustrate various embodiments of assemblable elements 1110, that may be assembled in various configuration to form a transmit area 1100 of FIG. 11A. As described above, assemblable elements 1110a-d may include a portion of transmit coil 1114, where each portion of transmit coil 1114 is illustrated as transmit coil portion 1114a-d. In some embodiments, each assemblable element 1110a-d may comprise some, all, or none of the transmit circuitry of FIGS. 1-6. For example, each assemblable element may include only a portion of a coil. Or each assemblable element may be a complete transmitter (e.g., transmitter 204 or 404 of FIGS. 2 and 4 respectively). The transmit coil portions 1114a-e may be arranged via interlocking components (not shown) disposed relative to connecting edge 1120a-c to form a complete transmit coil 1114 as shown in FIG. 11A. The interlocking components, as described above, may be a mechanical means to connect the tiles together (e.g., magnets, latches, snaps, etc.). FIGS. 11A-11E are schematic illustrations of some embodiments of assemblable elements, however the descriptions of features or aspects throughout the present disclosure are to be considered applicable for similar features or aspects in any of the various embodiment described in the present disclosure.

FIG. 11B illustrates a schematic perspective view of an embodiment of a turn assemblable element 1110a in accordance with an exemplary embodiment. Turn assemblable element 1110a comprises at least a portion of transmit coil 1114, for example turn coil portion 1114a. Turn assemblable element 1110a may also comprise interlocking edges 1120a which may comprise interlocking components 1125a (shown schematically) configured to facilitate interlocking of the plurality of assemblable elements. Turn coil portion 1114a may comprise wires, conductors, or other elements (e.g., conductors 1115a) configured to conduct or transmit an electrical circuit. The conductors 1115a may include an interconnection region, whereby the conductors of turn coil portion 1114a may be electrically interconnected to form a coil between the plurality of assemblable elements. For example, turn assemblable element 1110a may provide a turn or corner portion of the transmit coil 1114 of FIG. 11A. The curve of the conductors of the turn coil portion 1114a may be 90° turn, as illustrated in FIG. 11B. However, the turn may be any degree of turn as desired by the sought after arrangement for the transmit coil, for example, 5°, 10°, 50°, etc.

FIG. 11C illustrates a schematic perspective view of an embodiment of a straight assemblable element 1110b in accordance with an exemplary embodiment. Straight assemblable element 1110b comprises at least a portion of transmit coil 1114, for example straight coil portion 1114b. Straight assemblable element 1110b may also comprise interlocking edges 1120b, which may comprise interlocking components 1125b (shown schematically) configured to facilitate interlocking of the plurality of assemblable elements. Straight coil portion 1114b may also comprise conductors 1115b or other elements configured to transmit an electrical circuit. The conductors 1115b may include an interconnection region, whereby the straight coil portion 1114b may be electrically interconnected to form a coil between the plurality of assemblable elements.

FIG. 11D illustrates a schematic perspective view of an embodiment of power assemblable element 1110c in accordance with an exemplary embodiment. Power assemblable element 1110c comprises at least a portion of transmit coil 1114, for example power coil portion 1102 connected to a power source, such as for example, a DC to AC inverter. Power assemblable element 1110c may also comprise other coil portions, for example a cross over coil portion 1114c as depicted in FIG. 11C. However, the power assemblable element 1110c may also comprise a straight coil portion or a turn coil portion. In some embodiments, the power assemblable element 1110c may also include a cross-over coil portion such that that the outermost loop is not shorted. Power coil portion 1102 may be a power-in line configured to electrically connect to a power amplifier (e.g., power amplifier 424 of FIG. 4) either as part of power assemblable element 1110c or separate. In another embodiment, the power amplifier may be included in power assemblable element 1110c. Power assemblable element 1110c may also comprise interlocking edges 1120c which may comprise interlocking components 1125c (shown schematically) configured to facilitate interlocking of the plurality of assemblable elements. Power assemblable element 1110c may also comprise conductors 1115c or other elements configured to transmit an electrical circuit. The conductors 1115c may include an interconnection region, whereby the power assemblable element 1110c may be electrically interconnected to form a coil between the plurality of assemblable elements.

FIG. 11E illustrates a schematic perspective view of an embodiment of cross-over assemblable element 1110d in accordance with an exemplary embodiment. Cross-over assemblable element 1110d comprises at least a portion of transmit coil 1114, for example cross-over coil portion 1114d. Cross-over coil portion 1114d may be configured to provide a cross-over between loops of the transmit coil 1114. Cross-over assemblable element 1110d may also comprise interlocking edges 1120d which may comprise interlocking components 1125d (shown schematically) configured to facilitate interlocking of the plurality of assemblable elements. Cross-over coil portion 1114d may also comprise conductors 1115d or other elements configured to transmit an electrical circuit. The conductors 1115d may include an interconnection region, whereby the cross-over coil portion 1114d may be electrically interconnected to form a coil between the plurality of assemblable elements.

In some embodiments, the cross-over coil portion 1114d may include a plurality of switches 1117 configured to control cross-over of the coil portion 1114. FIG. 11C illustrates six switches 1117, one for each conductor 1115d, however, it will be understood that the number of switches 1117 need not be related to the number of conductors 1115d. For example, cross-over assemblable element 1110d may include a straight coil portion and/or a curved coil portion. Accordingly, cross-over assemblable element 1110d may be one means for dynamically reconfiguring the transmit coil based on the power transfer requirements of the receiver. For example, one or more switches 1117 of cross-over assemblable element 1110d may be operated to form one or more loops within the coil portion 1114. In some embodiments, the switches 1117 may be operated to form one or more transmit coils 1114 having one or more loops comprising one or more parallel turns. For example, a single transmit coil 1114 may contain a multiple loops where the turns for each loop are parallel. In another embodiment, in the alternative or in combination, switches 1117 may be configured to form passive parasitic loops that are not electrically connected to the other loops or the transmit circuitry.

In some implementations, the cross-over assemblable element 1110d may be configured to permit control over the turn density of the transmit coil 1114. In some embodiments, where one or more cross-over assemblable elements 1110d comprising one or more switches 1117 are used in a transmit area 1100 of FIG. 11A, switches 1117 may be configured to connect and disconnect one or more conductors 1115. For example, as described above in connection with FIGS. 1-6, the uniformity of a wireless field generated by the transmitter of a wireless power system is related to the turn density of the coil. In some implementations, turn density is increased near the outer edge of a transmitter to improve field uniformity.

Accordingly, with reference to FIG. 11A, a transmit area 1110 may comprise an outer region 1130 positioned near the outer edge of transmit area 1110. The transmit area 1110 may also comprise an inner region 1140 located near the center of the transmit area 1110. The transmit coil 1114 may be distributed throughout the inner and outer regions 1130 and 1140. For example, a first grouping of loops of transmit coil 1114 may constitute a first region 1130. This first grouping or subset of loops may have a loop density is related to the number of loops therein. Similarly, the inner region 1140 may comprise a second grouping or subset of loops of transmit coil 1114 having a second loop density. While FIG. 11A illustrates a select number of loops constituting a first or second region 1130 and 1140, it will be understood that the number of loops therein is not so restricted. The number of loops illustrated in FIG. 11A is for illustration purposes only, and may be greater or fewer as required to achieve the desired wireless field uniformity and power transfer efficiency.

A cross-over assemblable element 1110d may be included in the transmitter 1100 of FIG. 11A. Switches 1117 included in cross-over assemblable element 1110d may be configured to control the loop density of the first and second regions 1130 and 1140. For example, switches 1117 may disconnect and connect the various conductors 1115 of the portions of the transmit coil 1114. In some embodiments, the switches 1117 may be controlled to increase the number of loops making up the first grouping of loops. For example, transmit coil 1114 may have a plurality of conductors in the first region 1130, some of which may be active while others are inactive (e.g., the conductors making a loop are not electrically connected to the active regions of the transmit coil 1114). The switches 1117 may be configured to then connect the inactive conductors as to include the inactive loops in the active regions, thereby increasing the number of loops in the first region 1130. The loop density of the second region 1140 may be similarly controlled. Thus, the switches may be configured to periodically skip the one or more loops of the second region 1140. In this way, the loop density of the first region 1130 may be altered relative to the density of the second region 1140, thus the uniformity of the wireless field may be maintained.

In some implementations, switches 1117 may be controlled by a controller (not shown) similar to controller 415 of FIG. 4. As will be described below, the controller may be disposed in one or more assemblable elements, for example, in the cross-over assemblable element 1110d comprising the switches 1117, in a master assemblable element configured to control the operation of the transmit area 1100, or in any other assemblable element in electrical communication with the switches 1117. The controller may be configured to send a control signal to the cross-over assemblable element 1110d configured to cause one or more switches to complete a circuit or deactivate a current circuit. Accordingly, the switches 1117 may be electrically controlled or mechanically controlled.

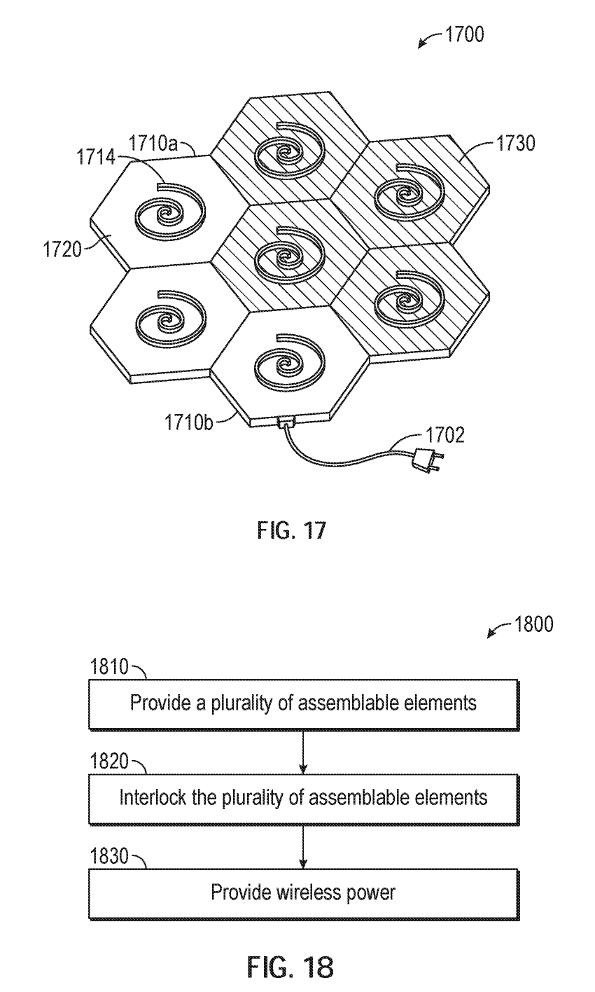

In some embodiments, the arrangement of assemblable elements 1110a-d may be determined by the user. In other embodiments, the arrangement of assemblable elements 1110a-d may be determined based on energy transfer requirements of the receiver. For example, some arrangements may be less suitable for efficiently transferring power to a given receiver, e.g., the generated wireless field is not efficiently coupled to the receiver coil or is not uniform across the receive coil. In some embodiments, the arrangement of the assemblable elements 1110a-d may be found on a look up table, where the arrangement is defined based on the requirements of a receiver. In some embodiments, the look up table may be stored in a database included in either the transmitter or an external or remote storage circuit. For example, in a case where the transmit area 1110 is configured to charge a single receiving device, the turns of the transmit coil 1114 may be evenly spaced to reduce losses, for example, due to capacitive coupling or other sources of loss. In another example, the transmit area 1114 may be configured to charge multiple receiving devices, the turns of the transmit coil 1114 may be concentrated near the periphery or edge of the transmit area 1114 to improve field uniformity. In some embodiments, software comprising instructions executed by a processor to retrieve said arrangements from the database may be configured to provide one or more arrangements of assemblable elements based on user inputs related to the receiver. For example, the user may input a receiver into a mobile device, which may access a database of known arrangements based on receiver requirements, and the mobile device may then display the appropriate known arrangements. In another embodiment, the transmitter may detect a size or type of receiver (as described below in connection with FIG. 17), and then execute instructions via a processor to retrieve appropriate arrangements and configure the coils therein accordingly. In some embodiments, the software may be an application on a mobile device, a computer, or a reference listing that is accessible by the user, for example, on the internet.

In some embodiments, the one or more appropriate arrangements of assemblable elements 1110a-d for efficient power transfer may be unknown to the user. Due to the complexity of design for such arrangements, the processor executing the software can be configured to execute instructions to present to the user regarding one or more appropriate interlocking arrangements of the assemblable elements 1110a-d so as to construct a transmitter for a particular receiver. In some cases the processor may be operatively coupled to a controller (e.g., controller 415 of FIG. 4) and configured to control switches 1117 in a cross-over assemblable element 1110d. For example, the user may enter a desired size and shape, and the processor may provide instructions for configuring the assemblable elements, configuring the switches 1117, and/or the timing of connecting/disconnecting the switches 1117, such that the transmit coil is electrically interconnected to provide efficient and uniform transfer of wireless power. In another embodiment, a controller (e.g., controller 415 of FIG. 4) included in one or more of the assemblable elements can configure a subset arrangement of assemblable elements, for example, a subset of the assemblable elements that make up a transmitter. The subset of assemblable elements may be configured to provide energy transfer based on determining the presence or lack of presence of a receiver within the near-field of the topology of the subset assemblable elements. For example, as described below with reference to FIG. 17.

FIGS. 12A and 12B schematically illustrate a perspective view of an exemplary transmit area 1200 in accordance with an exemplary embodiment. Transmit area 1200 may be similar to transmit area 1100 of FIG. 11, the transmit area 1200 being configured to generate a wireless field for providing energy transfer to a receiver. The transmit area 1200 may comprise a plurality of assemblable elements illustrated as assemblable elements 1210a-b in FIG. 12A. While assemblable elements 1210a and 1210b are illustrated as turn and straight assemblable elements, it will be understood that the assemblable elements may be substantially similar to any assemblable element 1110a-d of FIG. 11B-E.

FIGS. 12A and 12B illustrate one configuration for interlocking the assemblable elements of transmit area 1200. For example, assemblable elements 1210a and 1210b comprise interlocking edges 1220a and 1220b, respectively, each having an interlocking component 1225a and 1225b thereon. In the embodiment illustrated in FIG. 12A, the interlocking component 1225a may be a male interlocking component configured to mechanically interlock with a female interlocking component 1225b (e.g., similar to a puzzle piece being fitted together). By fitting the male and female interlocking components 1225a and 1225b together the coil portions 1214a and 1214b may be electrically interconnected as illustrated in FIG. 12B.

Assemblable elements 1210a and 1210b are illustrated as square or rectangular. However, this need not be the case, and any shape may be used and any arrangement is possible. In one embodiment, the interlocking components need only facilitate the electrical connection of the coil portions 1214 and 1214b to construct a complete coil 1214. The interlocking edges 1220a and 1220b need not meet or interlock, so long as interlocking components securely facilitate the electrical connection of the coil portions.

FIGS. 13A-13D schematically illustrate a perspective view of an exemplary transmit area 1300 in accordance with an exemplary embodiment. Transmit area 1300 may similar to transmit area 1100 of FIG. 11, but transmit area 1300 is a three-dimensional transmit area configured to generate a wireless field for providing energy transfer to a receiver. The transmit area 1300 may comprise a plurality of assemblable elements illustrated as assemblable elements 1310a-c in FIG. 13A. Assemblable elements 1310a-c may be any assemblable elements, for example, substantially similar to any assemblable element 1110a-d of FIGS. 11B-11E.

FIG. 13A depicts assemblable elements 1310a-c comprising interlocking edges 1320a-c, respectively, each having an interlocking component 1325a-c thereon. In the embodiment illustrated in FIG. 13A, the interlocking components 1325a and 1325b may be a fitted together either mechanically, electrically, magnetically, etc. to form transmit area 1300. Assemblable elements 1310a-c are illustrated as cube assemblable charging elements that may be assembled into the three-dimensional transmit area 1300. However, assemblable elements 1310a-c may be two-dimensional elements stacked or connected into a three-dimensional structure.

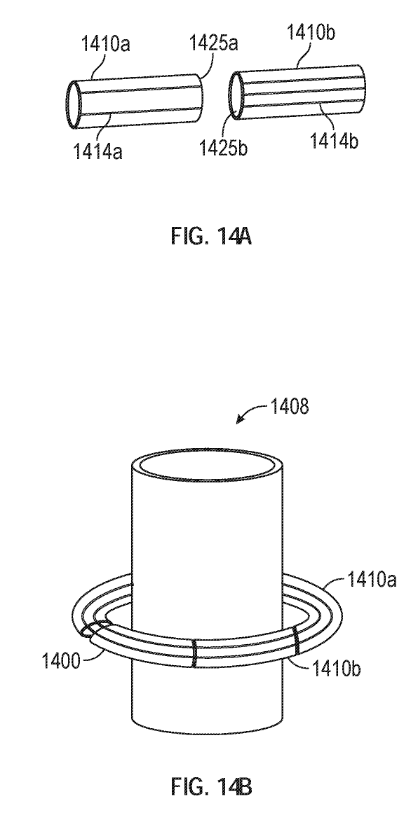

FIGS. 14A and 14B are a perspective view of another exemplary transmit area 1400 in accordance with an exemplary embodiment. FIG. 14B illustrates a tubular formed transmit area 1400 that may be configured to transfer power to a cylindrically shaped receiver 1408. Transmit area 1400 may be substantially similar to transmit area 1100 of FIG. 11A and transmit area 1300 of FIG. 13 (e.g., a three-dimensional transmit area).

Transmit area 1400 may also comprise a plurality of assemblable elements (e.g., assemblable elements 1410a and 1410b). The assemblable elements may similar to and include any of the assemblable elements 1110a-d of FIGS. 11B-11E, comprising coil portions 1414a and 1414b and interlocking edges 1425a and 1425b with interlocking components (not shown). Assemblable elements 1410a and 1410b may also be tubular in shape or may be cylindrical, however assemblable elements 1410a and 1410b need not be so limited. Assemblable elements 1410a and 1410b may also be flexible and/or malleable to facilitate bending to form the tubular transmit area 1400. In another embodiment, the assemblable elements 1410a and 1410b may be rigid but of a small enough size to approximate a tubular transmit area 1410 by placing the plurality of assemblable elements together. As illustrated in FIG. 14A, the coil portions 1414a and 1414b may comprise of conductors distributed throughout the surface area of the assemblable elements 1410a and 1410b. In other embodiments, the conductors may be disposed on a select region or portion of the assemblable elements or may be controlled by a cross-over assemblable element, as described above.

FIGS. 15A-15C schematically illustrate a perspective view of an exemplary transmit area 1500 in accordance with an exemplary embodiment. Transmit area 1500 may be similar to transmit area 1100 of FIG. 11, however, the assemblable elements 1510 may be hexagonally shaped and comprise at least one coil portion 1514a. The assemblable elements 1510 may be similar to assemblable elements 1110a-d of FIGS. 11B-11E.

FIG. 16 schematically illustrate a perspective view of an exemplary transmit area 1600 in accordance with an exemplary embodiment. Transmit area 1600 may be similar to transmit area 1100 of FIG. 11, however, the assemblable elements 1610 may have one or more different shapes capable of forming either a two-dimensional or a three-dimensional transmit area. For example, FIG. 16 illustrates a spherical transmit area 1600 comprising a plurality assemblable elements 1610a, each comprising at least one coil portion 1614a. The plurality of assemblable elements may be a combination of hexagonal assemblable elements 1610a and pentagonal assemblable elements 1610b. As such the transmit area 1600 may be a full sphere (e.g., having a pattern similar to a soccer ball) or a partial sphere (e.g., similar to a bowl). The assemblable elements 1610a and 1610b may be similar to assemblable elements 1110a-d of FIGS. 11B-11E. While a specific transmit area and assemblable elements are illustrated herein, it will be understood that any shaped transmit area and/or assemblable elements are possible.

In some implementations, a wireless power transfer system is provided comprising a transmit area. The transmit area may be made of a plurality of assemblable elements, where each assemblable element may be configured to permit interlocking between one or more of the plurality of assemblable elements. The plurality of assemblable elements may each include a portion of a coil configured to generate a wireless field for providing wireless power transfer. In some embodiments, as described above, the plurality of assemblable elements may be interlocked such that the coil portions are electrically interconnected and configured to provide wireless power. In some embodiments a control unit (e.g., in one or more of the assemblable elements) is provided. The control unit may be configured to instruct one or more coil portions to provide wireless power (e.g., an active area) and instruct the one or more other coil portions to not provide wireless power (e.g., an inactive area). The controller unit may be configured to determine which coil portion to instruct to provide wireless power based, in part, on power transfer or charging requirements of a receive coil relative to the coil portions.

In one implementation, the wireless power transfer system described above with respect to FIGS. 7-16, may be configured to vary a wireless power transfer based on a detection of a nearby receiver. In some embodiments, each assemblable element may comprise a power amplifier and the transmit circuitry (e.g., as described in FIGS. 1-6) configured to generate a wireless field to provide power transfer independently of the other assemblable elements. For example, a receiver may be positioned within the near-field of the wireless field generated by one or more of the assemblable elements. The wireless power transfer system may be configured to detect the presence of the receiver (or receive coil) relative to the subset of one or more assemblable elements, and then cause the subset of assemblable elements to generate a wireless field for providing wireless power transfer to the receiver. The remaining assemblable elements may remain inactive, thereby conserving power and reducing overall field exposure and radiation.

For example, as discussed above with respect to FIG. 4, a transmitter 404 can include the presence detector 480, which can detect the presence, distance, orientation, and/or location of a nearby object. In various other embodiments, the presence detector 480 can be located in another location such as, for example, on the receiver 508, or elsewhere. In another embodiment, the presence detector 480 may be included in one assemblable element of a transmitter 404, or each assemblable element may include a presence detector 480. Similarly, the transmitter 404 may include the load sensing circuit 416 which can detect the absence or presence of active receives in the transmitter 404's near-field. For example, load sensing circuit 416 can monitor the current flowing to driver 424 which can be affected by the presence or absence of active receivers. The controller 415 can increase transmission power or activate one or more assemblable elements when a receiver is detected within the near-field of the one or more assemblable elements. In some embodiments, the controller 415 may be included in each assemblable element and being operatively coupled there to facilitate the exchange of communication signals. In other embodiments, the controller 415 may be included in a single master assemblable element operatively coupled to other transmit circuitry included in each of the assemblable elements.

Referring back to FIG. 2, in certain embodiments, the wireless power transfer system 200 can include receivers 208 of various sizes. In one embodiment, the size of the transmit coil 214 is fixed. Accordingly, the transmit area of a transmitter 204 may not be well matched to different sized receive coils 218. For a variety of reasons, it can be desirable for the transmitter 204 to use a plurality of transmit coils 214 or one or more transmit coils 214 having a dynamically adjusted size and shape. In some embodiments, as described above, the transmit coils 214 can be arranged based an arrangement of the assemblable elements as described above with respect to FIGS. 11A-E. Similarly, the transmit coils 214 may be dynamically controlled via one or more switches (e.g., switches 1117) where the transmit area includes a cross-over assemblable element (e.g., cross-over assemblable element 1110d). In some embodiments, the transmit coils 214 can be modular, whereby each assemblable element comprises a complete transmit coil 214. In some embodiments, the array can include transmit coils 214 of the same, or substantially the same, size.

In various embodiments, each transmit coil 214 can be independently activated, based on detecting the presence or absence of receivers 208 and/or the size of their receive coils 218. For example, a single transmit coil 214 can provide wireless power to nearby receivers 208 having relatively small receive coils 218. On the other hand, multiple transmit coils 214 can be provide wireless power to nearby receivers having relatively large receive coils 218. Transmit coils 214 that are not near receive coils 218 can be deactivated.

In another embodiment, portions of transmit coil 214 can be connected and/or skipped in accordance with the above description of FIGS. 11A-11E, based on detecting the presence or absence of receivers 208 and/or the size of receive coils 218. For example, one or more loops of transmit coil 214 may be connected or disconnected via switches, such as switches 1117 to modify and adjust loop density of the coil 214. Accordingly, switches 1117 may be controlled by a controller, for example, controller 415 of FIG. 4, based on the presence or absence of a receiver 208.

In some embodiments, the plurality of transmit coils 214 can form a large transmit area. The transmit area can be scalable, covering a larger area using additional transmit coils 214. The transmit coils 214 can allow for free positioning of devices over a large area. Moreover, they can be configured to simultaneously charge a plurality of receivers 208. In some embodiments, individual transmit coils 214 can be coupled to each other via communication and synchronization lines configured to exchange control signals.

FIG. 17 is a perspective view of an exemplary transmit area 1700 in accordance with an exemplary embodiment. As shown, the transmit area 1700 includes a plurality of assemblable elements 1710a and at least one power source assemblable element 1710b. Power source assemblable element 1710b may comprise a power in line 1702 connected to a power source, such as for example, an AC-DC converter, a DC-DC converter, or directly from a conventional DC power source. The assemblable elements 1710a and 1710b may each comprise some, none, or all transmit circuitry described above in relation to FIGS. 1-6, each comprising components (e.g., coils, amplifiers, resonant components) described above.

For example, as described above in relation to FIG. 4, the assemblable elements may include a presence sensor 480 and/or load sensing circuit 416 configured to detect the presence or absence of a receiver. The presence sensor 480 and load sensing circuit 416 may be some means for detecting the presence or absence of a receiver. For example, transmit area 1700, which may include one or more active regions 1730 (comprising one or more assemblable elements) may be controlled to generate a wireless field based on detecting the presence of a receiver. Similarly, transmit area 1700 may also comprise inactive regions 1720 comprising one or more assemblable elements that are inactive due to detecting the absence (e.g., actively monitoring surroundings) of a receiver or not detecting that a receiver is present (e.g., passively reacting to the presence of a receiver). In some embodiments, a plurality of the assemblable element 1710a and 1710b (e.g., all or a subset of the assemblable elements) may include a means for detecting a receiver. Or, in another embodiment, a single assemblable element may include a means for detecting the receiver, the means for detecting a receiver being operatively coupled to one or more controllers and configured to control the transmit coils to generate one or more wireless fields.

The assemblable elements 1710a and 1710b are shown as being hexagonal; however, in some embodiments, the transmit coils may be of any other shape (e.g., triangular, circular, hexagonal, etc.). The transmit coils 1714 are shown as being circular; however, the transmit coils may be of any other shape. In some embodiments, the transmit coils may form an array of transmit coils, wherein each transmit coil is positioned substantially adjacent to the other transmit coils of the transmit area 1700. In some embodiments, the transmit coils may be positioned in an overlapping manner, wherein each of the transmit coils may overlap with one or more other transmit coils in the transmit area 1700. In another embodiment, the transmit coils may be portions of one or more dynamically reconfigurable transmit coils configured into a plurality of transmit coils disposed throughout the assemblable elements 1710a and 1710b. For example, as described above in accordance with FIG. 11A, each assemblable element may comprise a portion of one or more transmit coils, which may be electrically interconnected due to interlocking the assemblable elements 1710a and 1710b. Additionally, the transmit coils depicted in FIG. 17 may be multi-turn coils. However, in other embodiments, the transmit coils may be single turn coils and may be either single- or multi-layer coils. In some embodiments, the transmit coils may have inductances of 2000nH. In other embodiments, the transmit coils may have inductances greater than or less than 2000 nH. In other embodiments, each of the transmit coils may have inductances of different values, or various combinations of transmit coils may share inductances of different values.

In some embodiments, assemblable element 1710b may be a main or master assemblable element. Assemblable element 1710b may comprise power in line 1702 connected to a power source. Remaining assemblable elements 1710a may include electrical connections or lines (not shown) operatively coupled between neighboring assemblable elements and configured to distribute power (e.g., AC or DC power) from assemblable element 1710b to active region 1730 to generate a desired wireless field based on the detected receiver.

In some embodiments, the assemblable elements 1710a and 1710b may include a synchronization line (not shown) configured to facilitate synchronization and control of the phase of the transmit coils 1714. For example, synchronization line may be disposed between oscillators (e.g., oscillator 423 of FIG. 4) of various assemblable elements so that a controller (e.g., controller 415 of FIG. 4) may adjust the frequency or phase of the oscillators of each assemblable element, thereby adjusting the output power and phase synchronization of the multiple transmit coils.

In some embodiments, alternatively or in combination, the assemblable elements 1710a and 1710b may comprise a communication line (not shown) configured to permit the exchange of communication and control signals between the plurality of assemblable elements 1710a and 1710b. The communication line may permit an exchange of information concerning characteristics of the wireless power transfer (e.g., information pertaining charging power levels, presence or absence of a receiver, defining the active and/or inactive regions, etc.). In some embodiments, the communication line may be a means for coordinating the wireless power transfer of the transmit area 1700 based on the exchanged information. For example, the transmit circuits may each be configured to generate a wireless field by the associated transmit coils based on a signal generated by the power amplifiers in response to the exchanged information, as discussed above in relation to FIG. 4.

As described above, the assemblable elements 1710a and 1710b may each comprise some or all of the transmit circuitry described above in relation to FIGS. 1-6. Such circuitry need not be included for each assemblable element 1710a. For example, each assemblable element may comprise one or more components of the transmit circuitry. In some embodiments, the assemblable elements comprise at least a power amplifier (not shown), for example, power amplifier 424 of FIG. 4, and a transmit coil 1714.

In one embodiment, each assemblable element 1710a and 1710b may be substantially similar to the transmitters described in connection with FIGS. 1-6. Thus, each assemblable element 1710a and 1710b comprises all the transmit circuitry described above, including, for example, an AC-DC converter (not shown), controller 415, oscillator 222, driver circuit 224, etc. of FIGS. 2-6. Each assemblable element 1710a and 1710b may receive AC power directly from the power source via power in/out lines (not shown). The transmit coils 1714 are interconnected via the power in/out lines that extend throughout and between the assemblable elements 1710a and 1710b. In some embodiments, the interlocking of the assemblable elements 1710a and 1710b facilitates the electrical interconnection of the transmit coils 1714 through the power in/out lines. Assemblable elements 1710a and 1710b may comprise two power lines, for example, an AC power in or AC power out line, as shown in Table 1 below.

TABLE 1

| Number | Signal name |
|---|---|
| 1 | AC power |
| | out |
| 2 | AC power in |

In another embodiment, each assemblable element 1710a comprises some of the transmit circuit described in above, including, for example, an AC-DC converter (not shown), controller 415, oscillator 222, driver circuit 224, etc. of FIGS. 2-6. Thus, each of assemblable elements 1710a and 1710b may be substantially similar in function and can be independently driven by the transmit circuitry therein. However, in one embodiment, each assemblable element 1710a and 1710b does not include oscillators (e.g., oscillators 222 of FIG. 2). Thus, at least one assemblable element may include an oscillator configured to maintain a phase of the wireless field (e.g., at 6.78 MHz phase, however other phases and frequencies are possible). The remaining assemblable elements comprise a synchronization line configured to control the phase across the coils 1714. Thus, the transmit coils 1714 may be interconnected through power lines (not shown), as described above, and the phase may be controlled via at least one synchronization line operatively coupling each assemblable element. In some embodiments, the interlocking of the assemblable elements 1710a and 1710b facilitates the electrical interconnection of the transmit coils 1714 through the power lines and the interconnection of the synchronization line. Assemblable elements 1710a and 1710b may comprise three electrically interconnected lines, for example, a AC power in (e.g., AC hot), AC power out (e.g., AC neutral), and a synchronization line, as shown in Table 2 below.

TABLE 2

| Number | Signal name | Description | Notes |
|---|---|---|---|
| 1 | AC hot | | |
| 2 | AC neutral | | |
| 3 | Sync | 6.78 MHz | Configured to sync |
| | | phase-accurate | one or more assemblable |
| | | signal | elements |

In another embodiment, main assemblable element 1710b may be a power assemblable element having power input line 1702 connected to a power source, such as for example, an AC-DC converter. Remaining assemblable elements 1710a may not include such a converter, while still comprising, at least, power amplifiers 424 and controllers 415 of FIG. 4. Thus, main assemblable element 1710b may be configured to distribute DC power amongst the plurality of assemblable elements 1710a via the AC-DC converter. In some embodiments, the main assemblable element 1710b may be configured, for example, to convert an AC power source to DC power to generate a fixed DC power level (e.g., 12 volts) or vary the DC voltage level based on the demands of the rest of the system. For example, in the case of a charger intended to charge multiple devices, the voltage may be increased as more devices are added, to ensure enough power is available (given a relatively constant coil current) to charge all devices that are placed on the charger. Similar to previously described embodiments and as shown in Table 3, the assemblable elements 1710a may comprise a single synchronization line along with the power in and power out lines (e.g., DC+ and/or DC-lines) configured to supply power amongst the assemblable elements. In some embodiments, an optional communication line may be interconnected between the assemblable elements 1710a and 1710b configured to coordinate DC power levels in the event that the system requires varying DC power.

TABLE 3

| Number | Signal name | Description | Notes |
|---|---|---|---|
| 1 | DC+ | Power | |
| 2 | DC− | Power | |
| 3 | Sync | 6.78 MHz | Configured to sync one or |
| | | phase-accurate | more assemblable |
| | | signal | elements |
| 4 (opt) | Comm | Communications | Optional |
| | | line | |

In another embodiment, assemblable element 1710b may be a master assemblable element 1710b configured to control and monitor the functions of the assemblable elements 1710a (e.g., slave assemblable elements). In this embodiment, assemblable element 1710b may comprise a AC-DC converter configured to supply DC power, as described above, to the remaining assemblable elements 1710a; provide a master clock for controlling synchronization of the phase of the assemblable elements 1710a (e.g., a master oscillator 222); and a controller 415 of FIG. 4 configured to control the power transfer and wireless fields generated by each transmit coil 1714. The assemblable elements 1714 may comprise only power amplifiers 424 of FIG. 4 and transmit coils 1714 for generating the wireless field. Thus, as shown in Table 4, each assemblable element may comprise four lines for managing and controlling the wireless power transfer, e.g., a power in line, a power out line, a master clock line, and a control communications line.

TABLE 4

| Number | Signal name | Description | Notes |
|---|---|---|---|
| 1 | DC+ | Power | |
| 2 | DC− | Power | |
| 3 | Clock | Master clock | Used by all pads |
| 4 | Comm | Control line | Control signals to other pads |

FIG. 18 is a flowchart 1800 of an exemplary method of wireless power transfer in accordance with an exemplary embodiment. Although the method of flowchart 1800 is described herein with reference to the wireless power transfer system 100 discussed above with respect to FIGS. 1-2, the transmitter discussed above with respect to FIG. 4, and the transmit areas discussed above with respect to FIGS. 10-17, in some embodiments, the method of flowchart may be implemented by another device described herein, or any other suitable device. In some embodiments, the blocks in flowchart 1800 may be performed by a processor or controller, such as, for example, the controller 415 (referenced in FIG. 4), and/or the processor-signaling controller 516 (referenced in FIG. 5). In other embodiments, the blocks in flowchart 1800 may be performed based on or in conjunction with a smart application as described herein. Although the method of flow chart 1800 is described herein with reference to a particular order, in various embodiments, blocks herein can be performed in a different order, or omitted, and additional blocks may be added.

At block 1810, a plurality of assemblable elements are provided. For example, the assemblable elements may be similar to assemblable elements 1110a-d of FIGS. 11A-11E. The assemblable elements may be configured to interlock, as described above, between one or more of the neighboring assemblable elements. The assemblable elements may also comprise a transmit coil or a portion of a transmit coil. In some embodiments, any one assemblable element may not be able to generate a wireless field on its own, but a plurality of assemblable elements may be configured to generate a wireless field. The assemblable elements may individually or collectively comprise one or more components of transmit circuitry of FIG. 1-6, as described above.

At block 1820, the plurality assemblable elements may be interlocked to form a single structure or arrangement of elements. The structure may form a transmit area having one or more transmit coils. In some embodiments, the assemblable elements may be selectively interlocked based on the wireless power transfer requirements of the transmitter and/or receiver. For example, the assemblable elements may be interlocked as described above in FIGS. 11A-11D. In some embodiments, the assemblable elements may be interlocked or arranged to generate wireless field based on the shape, size, etc. of the receiver as detected by a means for detecting the presence or absence of the receiver. In some embodiments, the arrangement of assemblable elements may be predetermined based on the power transfer requirements, shape, size, etc., of the receiver. The predetermined arrangement may be retrieved from a database of arrangements. The interlocking of the assemblable elements may also facilitate the electrical interconnection of one or more portions of the transmit coil, thereby forming one or more dynamically reconfigurable transmit coils as described herein. Further, the interlocking of assemblable elements may electrically connect synchronization lines, communication lines, and other transmit circuitry configured to permit the control of one or more regions of the transmit area.

At block 1830, the plurality of assemblable elements may be configured to provide wireless power transfer. In some embodiments, the assemblable elements may be driven by transmit circuitry to generate a wireless field based on the transmit coils formed through electrically interconnecting the portions of transmit coils. The wireless field may be used to wirelessly transfer power to or wirelessly communicate with another device (e.g., a receiver).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

Information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the embodiments of the present disclosure.

The various illustrative blocks, modules, and circuits described in connection with the embodiments disclosed herein can be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein can be embodied directly in hardware, in a software module executed by a processor, or in a combination of the two. If implemented in software, the functions can be stored on or transmitted over as one or more instructions or code on a tangible, non-transitory computer-readable medium. A software module can reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium can be integral to the processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer readable media. The processor and the storage medium can reside in an ASIC. The ASIC can reside in a user terminal. In the alternative, the processor and the storage medium can reside as discrete components in a user terminal.

For purposes of summarizing the disclosure, certain aspects, advantages and novel features of the present disclosure have been described herein. It is to be understood that not necessarily all such advantages can be achieved in accordance with any particular embodiment of the present disclosure. Thus, the present disclosure can be embodied or carried out in a manner that achieves or optimizes one advantage or group of advantages as taught herein without necessarily achieving other advantages as can be taught or suggested herein.

Various modifications of the above described embodiments will be readily apparent, and the generic principles defined herein can be applied to other embodiments without departing from the spirit or scope of the present disclosure. Thus, the present disclosure is not intended to be limited to the embodiments shown herein but is to be accorded the widest scope consistent with the principles and novel features disclosed herein.

What is claimed is:

1. A device for distributing power, the device comprising:
a plurality of assemblable elements, each assemblable element configured to permit interlocking between one or more of the plurality of assemblable elements, the plurality of assemblable elements comprising at least:
a first assemblable element comprising a first portion of a coil; and
a second assemblable element comprising a second portion of the coil,
wherein the first and second portions of the coil are electrically interconnected and configured to provide wireless power.

2. The device of claim 1, wherein each assemblable element of the plurality of assemblable elements comprises a portion of the coil, wherein the portions of the coil are electrically interconnected to form one or more coils.

3. The device of claim 2, wherein wireless power is provided based on the electrical interconnection of all the portions of the coil.

4. The device of claim 1, wherein the first assemblable element is configured to supply power from a power source to the plurality of assemblable elements.

5. The device of claim 1, wherein the plurality assemblable elements are interconnected in an arrangement.

6. The device of claim 1, wherein the plurality of assemblable elements comprise an interlocking element, configured to permit the plurality of assemblable elements to be mechanically interconnected.

7. The device of claim 1, wherein the plurality of assemblable elements further comprises at least a third assemblable element comprising a third portion of the coil, and wherein the first, second and third portions of the coil are electrically interconnected and configured to provide wireless power.

8. The device of claim 1, wherein the plurality of assemblable elements are arranged in a two-dimensional arrangement.

9. The device of claim 1, wherein the plurality of assemblable elements are arranged in a three-dimensional arrangement.

10. The device of claim 1, wherein the coil comprises a plurality of loops, having at least a first and second loop, wherein the plurality of loops are based on the electrical interconnection of the plurality of assemblable elements.

11. The device of claim 10, wherein the first loop is disposed on an outer most edge of the interlocking plurality of assemblable elements and the second loop is disposed concentric to and nested within the first loop.

12. The device of claim 11, wherein an assemblable element of the plurality of assemblable elements is a crossover assemblable element, comprising one or more switches configured to control a density of loops at the outer edge of the interlocked plurality of assemblable elements, and configured to periodically skip the second loop.

13. The device of claim 10, wherein the plurality of loops comprises a passive loop.

14. The device of claim 1, wherein the assemblable elements are tubular assemblable elements, wherein the plurality of assemblable elements are configured to interlock to form a tubular shaped coil.

15. The device of claim 1, wherein the first and second portions of the coil are electrically interconnected through a coil in line and a coil out line.

16. A method for distributing power, the method comprising:
providing a plurality of assemblable elements, each assemblable element configured to interlock between one or more of the plurality of assemblable elements, wherein the each of the plurality of assemblable elements comprises a portion of a coil;
selectively interlocking the plurality of assemblable elements, wherein interlocking the assemblable elements electrically interconnects the portions of the coil; and
providing wireless power by the coil.

17. The method of claim 16, further comprising retrieving a predetermined arrangement for interlocking the plurality of assemblable elements stored in a database.

18. The method of claim 17, wherein selectively interlock the plurality of assemblable elements is based on the predetermined arrangement of the plurality of assemblable elements.

19. The method of claim 17, wherein the predetermined arrangement is two-dimensional.

20. The method of claim 17, wherein the predetermined arrangement is three-dimensional.

21. The method of claim 16, further comprises forming one or more coils by electrically interconnecting the portions of coil of the plurality of assemblable elements.

22. The method of claim 16, further comprising supplying power from a power source to the plurality of assemblable elements via one of the plurality of assemblable elements.

23. The method of claim 16, wherein selectively interlocking the plurality of assemblable elements further comprises forming a coil comprising a plurality of loops based on electrically interconnecting the portions of the coil.

24. The method of claim 23, wherein the plurality of loops comprises a first loop and a second loop, the first loop disposed on a periphery of the interlocking plurality of assemblable elements and the second loop is disposed concentric to and nested within the first loop.

25. The method of claim 24, further comprising controlling a density of loops at the periphery based a crossover assemblable element comprising one or more switches.

26. A device for distributing power, the device comprising:
a first means for creating a charging coil, the first means comprising a first portion of the charging coil; and
a second means for creating a charging coil, the second means comprising a second portion of the charging coil,
wherein the first means for creating a charging coil is configured to interlock to the second means for creating a charging coil, and wherein the first and second portions of the charging coil are electrically interconnected and configured to provide wireless power based on the interlocking of the first and second means for creating a charging coil.

27. The device of claim 26, wherein the first and second means for creating a charging coil each comprise a means for interlocking configured to permit the first and second means for creating a charging coil to mechanically interconnected.

28. The device of claim 26, further comprising a third means for creating a charging coil, the third means for creating a charging coil comprising a third portion of the charging coil.

29. The device of claim 26, wherein the first and second portions of the charging coil are interconnected to form one or more coils, the coils comprising a plurality of loops.

30. The device of claim 29, wherein a first loop of the plurality of loops is disposed on a periphery of the device and a second loop of the plurality of loops is disposed concentric to and nested within the first loop.
